(19) United States
(12) Patent Application Publication
(10) Pub. No.: US 2022/0060794 A1
(43) Pub. Date: Feb. 24, 2022

(54) METHOD AND APPARATUS FOR PROVIDING POP-UP WINDOW FOR GUIDING A RERUN OF BROADCAST TO USER TERMINAL

(71) Applicant: SK STOA CO., LTD., Seoul (KR)

(72) Inventor: Dae Ho MYOUNG, Seoul (KR)

(73) Assignee: SK STOA CO., LTD., Seoul (KR)

(21) Appl. No.: 17/409,123

(22) Filed: Aug. 23, 2021

(30) Foreign Application Priority Data
Aug. 24, 2020 (KR) 10-2020-0106225

(51) Int. Cl. H04N 21/472; H04N 21/431; H04N 21/488

(52) U.S. Cl. CPC H04N 21/47202; H04N 21/4316; H04N 21/4882; H04N 21/47217; H04N 21/4314

(57) ABSTRACT

A method for generating a user interface includes receiving a broadcasting request signal for performing communication with a set-top box, transmitting the broadcasting request signal to a data server, receiving a broadcast transmission time of a broadcast video outputted from the data server to the user terminal, and transmitting a pop-up window that prompts broadcast rerunning, received from the data server, to the user terminal at a designated point in time, when the broadcast transmission time satisfies a preset criterion.

### CROSS-REFERENCE TO RELATED APPLICATION

This application is based on and claims priority under 35 U.S.C. § 119 to Korean Patent Application No. 10-2020-0106225, filed on Aug. 24, 2020, in the Korean Intellectual Property Office, the disclosure of which is incorporated by reference herein in its entirety.

### BACKGROUND

### 1. Field

One or more embodiments relate to a method and apparatus for providing a pop-up window for guiding a rerun of a broadcast video to a user terminal.

### 2. Description of the Related Art

A user watching a broadcast transmitted according to a defined schedule halfway may be unable to watch broadcasted video that has already run. Thus, the user may view a video uploaded to a server after the end of the broadcast or watch content of a previous video from rebroadcasting that is set according to a separate schedule. However, in broadcasting in which real-time watching matters, such as home-shopping broadcasting, a user may be potentially unable to use information obtainable from live broadcast while watching a rebroadcast or a video stored in the server.

Thus, there is a need for a technique for efficiently providing a previously broadcasted video to a user terminal watching a live broadcast halfway.

### SUMMARY

One or more embodiments include a method and apparatus for re-providing a broadcast video to a user terminal watching a broadcast halfway.

Additional aspects will be set forth in part in the description which follows and, in part, will be apparent from the description, or may be learned by practice of the presented embodiments of the present disclosure.

According to one or more embodiments, a method of providing a pop-up window for guiding rewatching of a broadcast includes receiving a broadcasting request signal for performing communication with a set-top box, transmitting the broadcasting request signal to a data server, receiving a broadcast transmission time of a broadcast video that is output from the data server to the user terminal, and transmitting a pop-up window for guiding rewatching of a broadcast, received from the data server, to the user terminal at a designated point in time, when the broadcast transmission time satisfies a preset criterion.

In an embodiment, the method may further include retransmitting, by a content transmission server, broadcast video data to the user terminal at a designated point in time, when a broadcasting rewatching request signal is received.

In an embodiment, the retransmitting, by the content transmission server, of the broadcast video data to the user terminal at the designated point in time, when the broadcasting rewatching request signal is received, may include retransmitting, by the content transmission server, the broadcast video data to the user terminal, before a designated time from an end time of a broadcast video, when the broadcasting rewatching request signal is received.

In an embodiment, the preset criterion may be that the broadcast transmission time is later than a reference time.

In an embodiment, the preset criterion may be that a broadcasting rewatching request signal is received when the broadcast transmission time is earlier than a reference time.

In an embodiment, the outputting of the pop-up window for guiding rewatching of a broadcast to the user terminal at the designated point in time may include outputting the pop-up window for guiding rewatching of a broadcast to the user terminal, before a designated time from an end time of a broadcast video.

According to one or more embodiments, a media providing server includes a communication module configured to perform communication with a set-top box and a processor, in which the processor is configured to receive a broadcasting request signal for performing communication with the set-top box, transmit the broadcasting request signal to a data server, receive a broadcast transmission time of a broadcast video that is output to a user terminal from the data server, and transmit a pop-up window for guiding rewatching of a broadcast, received from the data server, to the user terminal at a designated point in time, when the broadcast transmission time satisfies a preset criterion.

In an embodiment, the processor may be further configured to control a content transmission server to retransmit broadcast video data to the user terminal at a designated point in time, when a broadcasting rewatching request signal is received by the set-top box.

In an embodiment, the processor may be further configured to control a content transmission server to retransmit the broadcast video data to the user terminal before a designated time from an end time of a broadcast video, when the broadcasting rewatching request signal is received by the set-top box.

In an embodiment, the preset criterion may be that the broadcast transmission time is later than a reference time.

In an embodiment, the preset criterion may be that a broadcasting rewatching request signal is received when the broadcast transmission time is earlier than a reference time.

In an embodiment, the processor may be further configured to output the pop-up window for guiding rewatching of a broadcast to the user terminal, before a designated time from an end time of a broadcast video.

According to one or more embodiments of the present disclosure, a method of generating a user interface for a broadcast includes steps of (i) receiving a broadcasting request signal for performing communication with a set-top box, (ii) transmitting the broadcasting request signal to a data server, (iii) receiving, from the data server, a broadcast transmission time of a selected broadcast video output to the user terminal, (iv) during a live broadcast, generating a pop-up window that prompts rerunning of the selected broadcast video, and (v) transmitting the pop-up window to the user terminal at a designated point in time, when the broadcast transmission time satisfies a preset criterion.

In at least one variant, the method further includes steps of receiving a broadcast rerunning request signal, and retransmitting, by a content transmission server, the selected broadcast video to the user terminal at the designated point in time.

In another variant, retransmitting the selected broadcast video further comprises retransmitting, by the content transmission server, the broadcast video data to the user terminal, before a designated time from an end time of the selected broadcast video, when the broadcast rerunning request signal is received.

In further another variant, the preset criterion is that a broadcast rerunning request signal is received when the broadcast transmission time is earlier than a reference time.

In another variant, the method further includes outputting the pop-up window to the user terminal at the designated point in time before a designated time from an end time of the selected broadcast video.

According to one or more embodiments of the present disclosure, a media providing server includes a communication module configured to perform communication with a set-top box, and a processor. The processor is configured to receive a broadcasting request signal for performing communication with the set-top box, transmit the broadcasting request signal to a data server, receive a broadcast transmission time of a selected broadcast video output to a user terminal from the data server, and transmit a pop-up window that prompts rewatching of the selected broadcast video to the user terminal at a designated point in time, when the broadcast transmission time satisfies a preset criterion.

In at least one variant, the processor is further configured to control a content transmission server to retransmit the selected broadcast video to the user terminal at a designated point in time, when a broadcast rewatching request signal is received by the set-top box.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a system for providing a pop-up window for guiding a rerun of a broadcast according to an embodiment;

FIG. 2 is a block diagram for describing internal structures of a user terminal and a server that perform a method of providing a pop-up window for guiding the broadcast rerun or rewatching, according to an embodiment;

FIG. 3 is a flowchart of a method of providing a pop-up window for guiding the broadcast rerun or rewatching according to an embodiment;

FIG. 4 is a detailed view illustrating selected operations of FIG. 3; and

FIG. 5 shows an example of a graphical user interface (GUI) of a user terminal on which a pop-up window for guiding the broadcast rerun or rewatching is output according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Reference is made to the accompanying drawings, which show by way of illustration specific embodiments in which the disclosure may be practiced. These embodiments will be described in detail sufficiently to allow those of ordinary skill in the art to carry out one or more embodiments. It should be understood that various embodiments are different, but do not need to be mutually exclusive. For example, certain shapes, structures, and characteristics described herein may be implemented with changes from one embodiment to another, without departing from the spirit and scope of one or more embodiments. In addition, it should be understood that the location or arrangement of individual components in each embodiment may also be changed without departing from the spirit and scope of one or more embodiments. Therefore, the following detailed description is not to be taken in a restrictive sense, and the scope of one or more embodiments should be taken to cover the scope of the claims and all equivalents thereto. Throughout the drawings, like reference numerals refer to the same or similar components over various aspects.

Hereinafter, to allow those of ordinary skill in the art to easily carry out one or more embodiments, various embodiments will be described in detail with reference to the accompanying drawings.

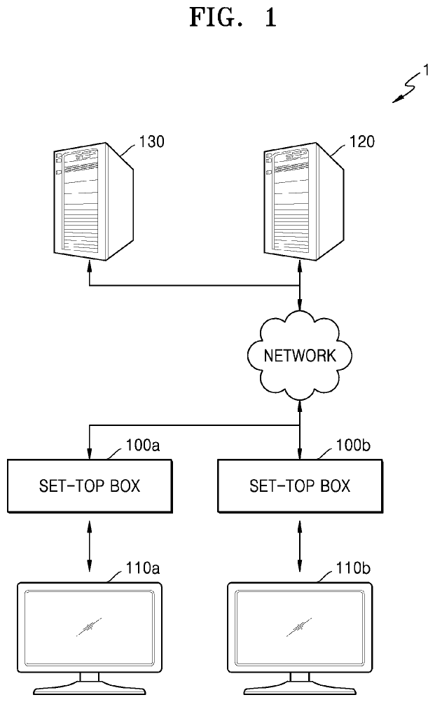

FIG. 1 illustrates an example of a system 1 for providing a pop-up window for guiding a rerun or rewatching of a broadcast. The system 1 performs a process of providing a pop-up window for guiding a broadcast rerun or rewatching according to one or more embodiments.

The system 1 according to one or more embodiments may include set-top boxes 100a and 100b, and user terminals 110a and 110b, a media providing server 120, and a data server 130. Additionally, the system 1 may further include a content transmission server according to several embodiments.

The set-top boxes 100a and 100b, the media providing server 120, and the data server 130 may perform communication over a network, and the set-top boxes 100a and 100b may communicate with at least one user terminals 110a and 110b.

The set-top boxes 100a and 100b are hardware devices generally necessary for watching satellite broadcasting or cable broadcasting at home, in which the satellite broadcasting or the cable broadcasting may be transmitted as a digital signal to a home television (TV), and the set-top boxes 100a and 100b may reconstruct a signal to watch the received digital signal through the user terminals 110a and 110b such as a TV, etc., convert a demand of a subscriber into a control signal, and transmit the control signal to a corresponding module.

Meanwhile, the set-top boxes 100a and 100b may process broadcast output data through a program installed in the set-top boxes 100a and 100b. The set-top boxes 100a and 100b may read a platform code, a segmentation-targeting-positioning (STD) identifier (ID), access information, etc., of the set-top boxes 100a and 100b to generate output data based on them. The set-top boxes 100a and 100b may control an external output device (e.g., the user terminals 110a and 110b) to output the output data.

The set-top boxes 100a and 100b may transmit a user request signal acquired through, for example, a remote control, etc., to the media providing server 120, receive image identification information of commerce content corresponding to the user request signal from the media providing server 120, and request broadcast video data (e.g., video on demand (VOD) data) corresponding to the image identification information from the content transmission server.

The user terminals 110a and 110b, which are connected to the set-top boxes 100a and 100b, may receive and output the output data processed and/or generated in the set-top boxes 100a and 100b. For example, the user terminals 110a and 110b may display a screen according to screen data and output voice according to voice data. The user terminals 110a and 110b may be directly connected to the set-top boxes 100a and 100b through a cable, etc. However, one or more embodiments are not limited thereto, and the user terminals 110a and 110b such as a TV may be directly connected to a network, and in this case, may be connected to the set-top boxes 100a and 100b through the network depending on a need.

The data server 130 is a computing device in which a server program such as Apache Tomcat®, Oracle, etc., is installed, and may be implemented to process server functions. As described above, the data server 130 may store product information, and/or deliberation information including deliberation completion/progress status values of content.

The data server 130 may store image identification information, pop-up data, etc., and provide related information to the media providing server 120 in response to a request of the media providing server 120. The image identification information may be used to call a broadcast video stored in the content transmission server. The image identification information may be, for example, playback uniform resource locator (URL) information stored in the content server 200. The set-top boxes 100a and 100b may read the image identification information included in the output data received from the media providing server 120 and receive a broadcast video from the content transmission server. The set-top boxes 100a and 100b may receive the broadcast video from the content transmission server without passing through the media providing server 120 and the data server 130.

The media providing server 120 may drive and control an application based on a control signal transmitted from the set-top boxes 100a and 100b. The media providing server 120 may generate application screen data regarding the application. The application screen data may be data regarding an application screen to be implemented (e.g., displayed) on screens of the user terminals 110a and 110b. The media providing server 120 may transmit the generated application screen data to the set-top boxes 100a and 100b. For example, the media providing server 120 may transmit the generated application screen data and the image identification information (e.g., the playback URL information) corresponding to a control signal of the user, together, to the set-top boxes 100a and 100b. The media providing server 120 may be, for example, a cloud server.

In an embodiment, the data server 130 may transmit pop-up contents output from the user terminals 110a and 110b to the set-top boxes 100a and 100b through the media providing server 120. In some embodiments, the data server 130 may transmit the above-described pop-up contents to the set-top boxes 100a and 100b through the media providing server 120, when a broadcasting transmission time satisfies a preset condition.

In other embodiments, the set-top boxes 100a and 100b may perform network communication with the at least one user terminals 110a and 110b. A scheme of the network communication is not limited, and, for example, may perform short-range wireless communication. The set-top boxes 100a and 100b may receive a broadcast video from the content transmission server and transmit the broadcast video to the user terminals 110a and 110b.

In some embodiments, the user terminals 110a and 110b may receive broadcast video data and pop-up contents from the set-top boxes 100a and 100b and output the above-described broadcast video and pop-up contents to a display.

In other embodiments, the content transmission server may transmit the broadcast video data to the set-top boxes 100a and 100b according to a designated broadcasting schedule. The content transmission server may temporarily or permanently store an already transmitted broadcast video. That is, the content transmission server may receive a broadcasting request signal from the set-top boxes 100a and 100b, independently of reception of the broadcasting request signal by the media providing server 120 from the set-top boxes 100a and 100b, and transmit the corresponding broadcast video data to the set-top boxes 100a and 100b.

In some embodiments, the media providing server 120 may obtain the broadcasting request signal received from the set-top box (100a or 100b) to the user terminal (110a or 110b) and transmit the broadcasting request signal to the data server 130. The media providing server 120 may receive the broadcasting transmission time from the data server 130. When the broadcasting transmission time satisfies a designated criterion, the media providing server 120 may transmit a pop-up window for guiding broadcast rewatching, received from the data server 130, to the user terminal (110a or 110b).

Meanwhile, in response to a signal for requesting broadcasting rerun or rewatching (or a broadcasting rewatching request signal), the set-top box (100a or 100b) may receive again broadcast video data from the content transmission server. In this case, for rerunning or rewatching of a broadcast video from the beginning, the set-top box (100a or 100b) may receive again the entire broadcast video data or receive again broadcast video data corresponding to a section the user has not watched.

When the broadcasting transmission time satisfies the designated criterion, the pop-up window for guiding the broadcast rerunning or rewatching may be output at a designated point in time before the end of a broadcast video on the user terminal (110a or 110b) having transmitted the broadcast video data. When the user terminal (110a or 110b) receives a user input to the pop-up window for guiding the broadcast rewatching, the user terminal (110a or 110b) may re-output the broadcast video at a designated point in time. To this end, the media providing server 120 that provides the pop-up window for the broadcast rerun or rewatching according to several embodiments may provide a user with the entire broadcast video of at an optimal point in time in case a user has not finished watching the entire broadcast video or desires to watch the broadcast video again.

Meanwhile, in some embodiments, the data server 130, the media providing server 120, and the content transmission server may be separate servers which are provided at different locations.

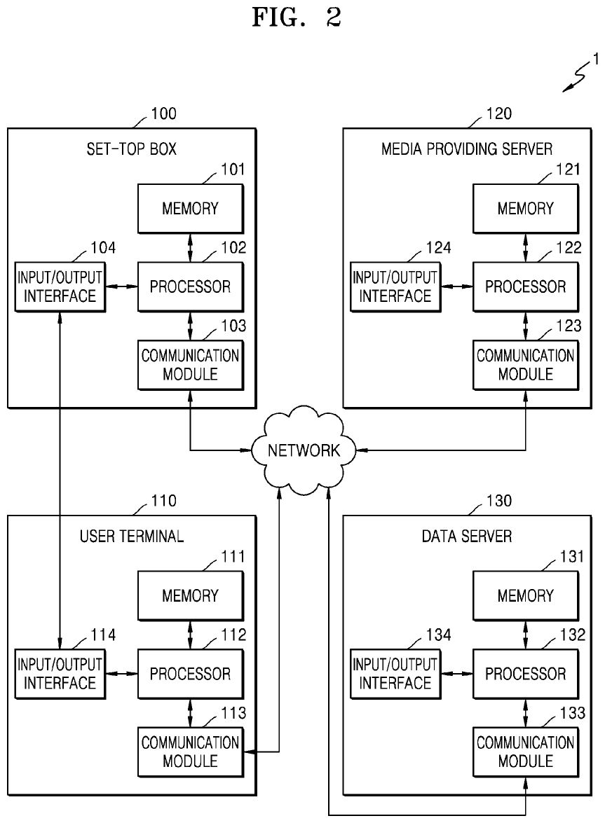

FIG. 2 is a block diagram for describing internal structures of a user terminal and a server that perform a method of providing a pop-up window for guiding broadcast rewatching, according to an embodiment.

In FIG. 2, as an example of a system for providing a pop-up window for guiding broadcast rewatching according to an embodiment, an internal structure of a set-top box 100, a user terminal 110, the media providing server 120, and the data server 130 will be described in detail.

In an embodiment, the set-top box 100, the user terminal 110, the media providing server 120, and the data server 130 that provide the pop-up window for guiding the broadcast rerunning or rewatching may include memories 101, 111, 121, and 131, processors 102, 112, 122, and 132, communication modules 103, 113, 123, and 133, and input/output interfaces 104, 114, 124, and 134, respectively.

The memories 101, 111, 121, and 131, as computer-readable recording media, may include a permanent mass storage device such as random access memory (RAM), read only memory (ROM), and disk drive. For example, the memory 111 included in the user terminal 110 may temporarily or permanently store a program code and settings for controlling the user terminal 110 and broadcast videos.

The processor 102, 112, 122, and 132 may be configured to process a command of a computer program by executing basic arithmetic, logic, and input/output operations. The command may be provided by the memories 101, 111, 121, and 131 or the communication modules 103, 113, 123, and 133 to the processors 102, 112, 122, and 132. For example, the processors 102, 112, 122, and 132 may be configured to execute a command received according to a program code stored in a recording device such as the memories 101, 111, 121, and 131. The processor 122 of the media providing server 120 according to an embodiment may receive a broadcasting request signal from the set-top box 100, transmit the broadcasting request signal to the data server 130, receive a broadcasting transmission time of a broadcast video output to the user terminal 110 from the data server 130. the content transmission server transmits the broadcast video that is output to the user terminal 110. The data server 130 transmits a pop-up window for guiding the broadcast rerunning or rewatching to the user terminal 110 at a designated point in time when the broadcasting transmission time satisfies a designated criterion.

The communication modules 103, 113, 123, and 133 may provide a function for communication through a network. In some embodiments, a request generated by the processor 112 of the user terminal 110 according to the program code stored in the recording device such as the memory 111 may be transmitted to the set-top box 100 through the network, under control of the communication modules 103, 113, 123, and 133. In another embodiment, a control signal, a command, content, a file, etc., provided under control of the processor 122 of the media providing server 120 may be received at the user terminal 110 through the communication module 103 of the user terminal 110 over the network. For example, the control signal, the command, etc., received through the communication modules 103, 113, 123, and 133 may be transmitted to the processors 102, 112, 122, and 132 or the memories 101, 111, 121, and 131, and the content, the file, etc., may be stored in a storage medium which may be further included in the set-top box 100, the user terminal 110, and the media providing server 120.

A communication scheme of the network is not limited, and the network may be a short-range wireless communication network. For example, the network may be a Bluetooth®, Bluetooth low energy (BLE), or wireless fidelity (WiFi) communication network. A communication scheme of a network used for communication between the set-top box 100 and the user terminal 110 and a communication scheme of a network used for communication between the media providing server 120 and the set-top box 100 may be different from each other.

The input/output interfaces 104, 114, 124, and 134 may be means for interfaces with an input/output device (not shown). For example, the input device may include a device such as a keyboard, a mouse, etc., and the output device may include a device such as a display for displaying a communication session of an application. In another example, the input/output interfaces 104, 114, 124, and 134 may be means for interfaces with a device into which functions for input and output are integrated, such as a touch screen. More specifically, the processor 112 of the user terminal 110 may display a service screen or content configured using data provided by the media providing server 120 or the set-top box 100 on a display through the input/output interface 114 to process the command of the computer program loaded in the memory 111.

In addition, in other embodiments, the set-top box 100, the user terminal 110, and the media providing server 120 may include components that are more than those of FIG. 2. However, most conventional technical components are not necessarily clearly illustrated. For example, the user terminal 110 may include a battery for supplying power to internal components of the user terminal 110 and a charging device, and may be implemented to include at least a part of the above-described input/output device or other components such as a transceiver, a global positioning system (GPS) module, various sensors, a database, etc.

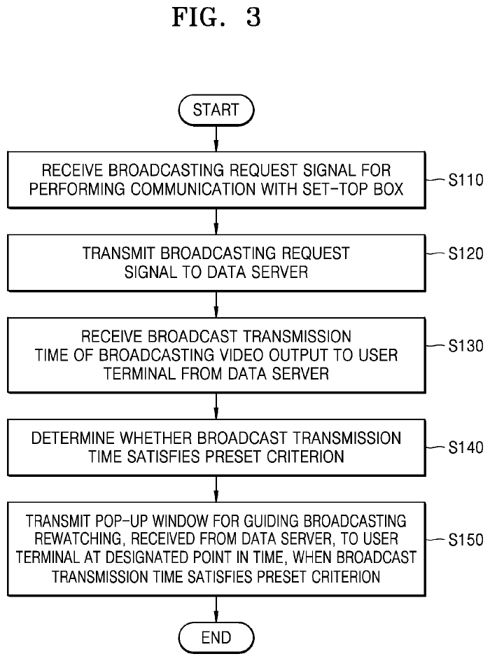

FIG. 3 is a flowchart of a method of providing a pop-up window for guiding the broadcast rerunning or rewatching, according to an embodiment.

Each process of the method of providing a pop-up window for guiding the broadcast rerunning or rewatching according to some embodiments may be performed by the media providing server (120) described with reference to FIGS. 1 and 2, but at least one process may be performed by the set-top box (100a or 100b) in another embodiment. For clear understanding of one or more embodiments, the following description will be made assuming that an apparatus for performing a method of providing a pop-up window for guiding the broadcast rerunning or rewatching is a media providing server, but an entity that performs each operation is not limited thereto. The set-top box (100a or 100b) may also be provided as a separate hardware device that performs network communication with the user terminal (110a or 110b), or may be included in the form of a software module included in the user terminal (110a or 110b).

In process S110, the media providing server may receive a broadcasting request signal for performing communication with the set-top box.

In process S120, the media providing server may transmit the broadcasting request signal to the data server.

In process S130, the media providing server may receive a broadcasting transmission time of a broadcast video output to the user terminal from the data server. In this case, the broadcast video output to the user terminal may be received from the content transmission server.

In an embodiment, the user terminal may receive broadcast video data transmitted according to a defined schedule from the content transmission server. A format of the broadcast video data is not limited, and the broadcast video data may be, for example, a streaming video transmitted in real time or a recorded VOD video.

The broadcasting transmission time received from the data server may be a time at which the content transmission server transmits a broadcast video according to a designated schedule.

Meanwhile, in another embodiment, the media providing server may transmit the broadcasting request signal to the data server, and the data server may transmit the received broadcast video data to the media providing server.

In process S140, the media providing server may determine whether the broadcasting transmission time satisfies a preset criterion.

In some embodiments, the media providing server may determine whether the broadcasting transmission time received from the data server satisfies the designated criterion. Alternatively, in another embodiment, the media providing server may determine whether the above-described broadcasting transmission time satisfies the designated criterion. In an embodiment, the media providing server may determine whether the broadcasting transmission time is later than a reference time. When the broadcasting transmission time is earlier than the reference time, the media providing server may determine whether the broadcasting rerunning or rewatching request signal is received.

In another embodiment, the media providing server may obtain operation information of a set-top box by using an identification value of the set-top box, and determine whether the operation information of the set-top box satisfies the designated criterion. For example, the media providing server may determine based on operation information of a set-top box having received home-shopping broadcasting whether the user has a history of purchasing a product from home shopping or whether the user has a history of purchasing a particular product. In this way, the media providing server may provide the pop-up window for guiding the broadcast rerunning or rewatching to a set-top box connected to a user terminal of a user who is likely to rewatch the home-shopping video or to purchase a product on sale in the home-shopping video.

In process S150, when the broadcasting transmission time satisfies a preset criterion, the media providing server may transmit the pop-up window for guiding the broadcast rerunning or rewatching, received from the data server, to the user terminal at a designated point in time. In this case, the user terminal may output the received pop-up window at the designated point in time.

The media providing server may receive the pop-up window from the data server, which is provided separately from the content transmission server. In an embodiment, the media providing server may transmit a signal for requesting output of the pop-up window to the user terminal, in response to the set-top box satisfying a preset condition. In another embodiment, the media providing server may transmit a signal outputting the pop-up window to the user terminal at the designated point in time before the end of the broadcast video.

In this case, the media providing server may output the pop-up window for guiding broadcast rerunning or rewatching to the user terminal, before a designated time from an end time of a broadcast video. For example, when a particular user terminal satisfies a preset criterion, the media providing server may transmit the signal outputting the pop-up window for guiding the broadcast rerunning or rewatching to the display of the user terminal, 30 minutes before the end of the broadcast video.

Thereafter, when a broadcasting rewatching request signal is received through the set-top box, the content transmission server may retransmit the broadcast video to the user terminal at a designated point in time. That is, the content transmission server may retransmit the broadcast video to the user terminal in response to reception of the broadcasting rerunning or rewatching request signal. The set-top box may receive a user input for requesting the broadcasting rerunning or rewatching through an input/output interface, and in this case, may transmit the broadcasting rerunning or rewatching request signal to the media providing server.

In another embodiment, when the content transmission server receives the broadcasting rerunning or rewatching request signal, the content transmission server may retransmit the broadcast video to the user terminal, before a specific time from the end time of a broadcast video. In other embodiments, even when the content transmission server receives the broadcasting rerunning or rewatching request signal, the content transmission server may retransmit the broadcast video after end of a broadcast video currently output on the user terminal, instead of immediately transmitting a previously stored broadcast video to the user terminal.

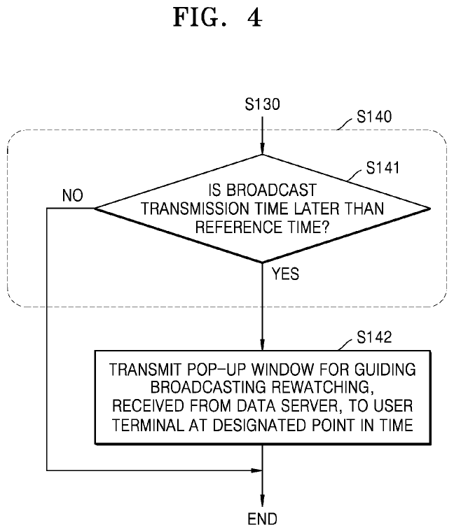

FIG. 4 is a detailed view illustrating the process S140 of FIG. 3.

In process S141, the media providing server may determine whether the broadcasting transmission time is earlier than or later than the reference time. The reference time according to several embodiments is not limited, and may be designated by the media providing server, a broadcast video producer, or the user terminal. The reference time may be a statically fixed value, or may be dynamically changed according to user's selection. For example, the reference time may be a point in time after a defined time from a broadcasting start time or before a defined time from a broadcasting end time. Alternatively, the reference time may be a designated point in time after occurrence of a particular event in home-shopping broadcasting. In this case, the particular event may be a point in time designated based on broadcasting contents in the home-shopping broadcasting, or may be a case where a designated criterion is satisfied based on product sales or the number of viewers.

In an embodiment, when the above-described broadcasting transmission time is later than the reference time, the media providing server may transmit the pop-up window for guiding the broadcast rerunning or rewatching received from the data server to the user terminal at a designated point in time, in process S150 (S142).

Meanwhile, in another embodiment, when the above-described broadcasting transmission time is earlier than the reference time, the media providing server may determine whether the broadcasting rewatching request signal is received. That is, the media providing server may further determine whether a user input for requesting broadcasting rewatching is received from the set-top box even when the broadcasting transmission time of the user terminal is earlier than the reference time.

In this case, when the media providing server fails to receive the broadcasting rewatching request signal, the pop-up window for guiding broadcast rewatching may not be output to the user terminal. That is, the media providing server may not transmit the pop-up window for guiding broadcast rewatching to the user terminal of the user who is not interested in the broadcast video or has no need to rewatch the broadcast video. In this case, by providing a broadcast video that is different from a previous broadcast video to the user, other contents in which the user may become interested may be provided to the user.

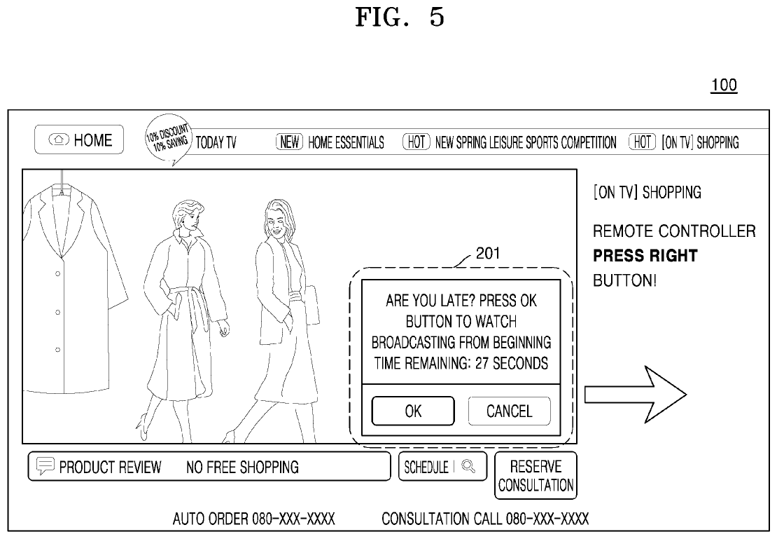

FIG. 5 shows an example of a graphic user interface (GUI) of a user terminal on which a pop-up for guiding the broadcast rerunning or rewatching is output, according to embodiments of the present disclosure.

The user terminal 110 according to an embodiment may include a display which may include a GUI region on which a broadcast video is output and a GUI region on which a pop-up window for guiding broadcast rerunning or rewatching is output. In this case, configurations and arrangement of the GUI region where the broadcast video is output and the GUI region where the pop-up window for guiding the broadcast rerunning or rewatching is output are not limited to illustration. Referring to the illustration, in an embodiment, the GUI region where the broadcast video is output and the GUI region where the pop-up window for guiding broadcast rerunning or rewatching is output may be partially overlapped and displayed, but according to another embodiment, the GUI region where the broadcast video is output and the GUI region where the pop-up window for guiding broadcast rerunning or rewatching is output may be displayed on separate areas. Moreover, the pop-up window for guiding broadcast rerunning or rewatching may be displayed in the center of the display of the user terminal or in an upper portion, a lower portion, or a side of the display.

Moreover, a configuration and a shape of a pop-up window 201 for guiding broadcast rerunning or rewatching according to several embodiments may not be limited to the illustration. In an embodiment, the pop-up window for guiding broadcast rerunning or rewatching may be displayed in the form of a banner in a side of the GUI region where the broadcast video is output and, in another embodiment, the pop-up window may be displayed as a UI object type in the form of a button inside or outside the GUI region where the broadcast video is output.

Referring to the illustration, the pop-up window 201 for guiding broadcast rerunning or rewatching may display words of guidance, such as “press OK button to watch broadcasting from the beginning”. Thereafter, in an embodiment, upon receipt of a user input to the ‘OK’ button, the set-top box may transmit a corresponding signal to the content transmission server. In this case, the content transmission server may retransmit the broadcast video to the user terminal 110 at a designated point in time. When the set-top box fails to receive any user input or receives a user input to a ‘CANCEL’ button, the set-top box may not transmit any signal to an electronic device or may transmit a signal indicating that the electronic device is not a terminal watching the broadcast video halfway.

The apparatus described above may be implemented by a hardware component, a software component, and/or a combination of the hardware component and the software component. For example, the apparatus and components described in the embodiments may be implemented using one or more general-purpose or special-purpose computers such as, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. A processing device may execute an operating system (OS) and one or more software applications running on the OS. The processing device may access, store, manipulate, process, and generate data in response to execution of software. For convenience of understanding, it is described that one processing device is used, but those of ordinary skill in the art would recognize that the processing device includes a plurality of processing elements and/or a plurality of types of processing elements. For example, the processing device may include a plurality of processors or one processor and one controller. Alternatively, other processing configurations such as parallel processors may be possible.

Software may include a computer program, a code, an instruction, or a combination of one or more thereof, and may configure a processing device to operate as desired or independently or collectively instruct the processing device. The software and/or data may be permanently or temporarily embedded in any type of machine, component, physical device, virtual equipment, computer storage medium or device, or signal wave to be transmitted, so as to be interpreted by or to provide instructions or data to the processing device. The software may be distributed over computer systems connected through a network and may be stored or executed in a distributed manner. The software and data may be stored in one or more computer-readable recording media.

The methods according to the embodiments may be received implemented in the form of program commands that can be executed through various computer components and recorded in a computer-readable recording medium. The computer-readable recording medium may include a program command, a data file, a data structure and the like solely or in a combined manner. The program command recorded in the computer-readable recording medium may be a program command specially designed and configured for the embodiments or a program command known to be used by those skilled in the art of the computer software field. Examples of the computer-readable recording medium may include magnetic media such as hard disk, floppy disk, and magnetic tape, optical media such as compact disk read only memory (CD-ROM) and digital versatile disk (DVD), magneto-optical media such as floptical disk, and a hardware device especially configured to store and execute a program command, such as read only memory (ROM), random access memory (RAM) and flash memory, etc. Examples of the program instructions include a machine language code created by a complier and a high-level language code executable by a computer using an interpreter. The foregoing hardware device may be configured to be operated as at least one software module to perform an operation of the embodiments, or vice versa.

While the embodiments of the disclosure have been described in connection with specific examples and drawings, it would be understood by a person skilled in the art that various modifications and changes may be possible from the foregoing disclosure. For example, even when described techniques are performed in a sequence different from the described method and/or components such as systems, structures, devices, circuits, etc. are combined or connected differently from the described method, or replaced with other components or equivalents, an appropriate result may be achieved.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of generating a user interface for a broadcast, the method comprising:
receiving a broadcasting request signal for performing communication with a set-top box;
transmitting the broadcasting request signal to a data server;
receiving, from the data server, a broadcast transmission time of a selected broadcast video outputted to a user terminal;
during a live broadcast, generating a pop-up window that prompts rerunning of the selected broadcast video; and
transmitting the pop-up window to the user terminal at a designated point in time, when the broadcast transmission time satisfies a preset criterion.

2. The method of claim 1, further comprising:
receiving a broadcast rerunning request signal; and
retransmitting, by a content transmission server, the selected broadcast video to the user terminal at the designated point in time.

3. The method of claim 2, wherein:
retransmitting the selected broadcast video further comprises:
retransmitting, by the content transmission server, the selected broadcast video to the user terminal, before a designated time from an end time of the selected broadcast video, when the broadcast rerunning request signal is received.

4. The method of claim 1, wherein the preset criterion is that the broadcast transmission time is later than a reference time.

5. The method of claim 1, wherein the preset criterion is that a broadcast rerunning request signal is received when the broadcast transmission time is earlier than a reference time.

6. The method of claim 1, further comprising outputting the pop-up window to the user terminal at the designated point in time before a designated time from an end time of the selected broadcast video.

7. A computer program stored in a storage medium to execute the method according to claim 1 by using a computer.

8. A media providing server comprising:
a communication module configured to perform communication with a set-top box; and
a processor,
wherein the processor is configured to:
receive a broadcasting request signal for performing communication with the set-top box;
transmit the broadcasting request signal to a data server;
receive a broadcast transmission time of a selected broadcast video outputted to a user terminal from the data server; and
transmit a pop-up window that prompts rewatching of the selected broadcast video to the user terminal at a designated point in time, when the broadcast transmission time satisfies a preset criterion.

9. The media providing server of claim 8, wherein the processor is further configured to control a content transmission server to retransmit the selected broadcast video to the user terminal at a designated point in time, when a broadcast rewatching request signal is received by the set-top box.

10. The media providing server of claim 9, wherein the processor is further configured to control the content transmission server to retransmit the selected broadcast video to the user terminal before a designated time from an end time of the selected broadcast video, when the broadcast rewatching request signal is received at the set-top box.

11. The media providing server of claim 8, wherein the preset criterion is that the broadcast transmission time is later than a reference time.

12. The media providing server of claim 8, wherein the preset criterion is that a broadcast rewatching request signal is received when the broadcast transmission time is earlier than a reference time.

13. The media providing server of claim 8, wherein the processor is further configured to output the pop-up window to the user terminal, before a designated time from an end time of the selected broadcast video.
